(19) United States
(12) Patent Application Publication
(10) Pub. No.: US 2026/0055930 A1
(43) Pub. Date: Feb. 26, 2026

(54) ENERGY HARVESTING DEVICE

(71) Applicant: Chi Lam Leung, Singapore (SG)

(72) Inventor: Chi Lam Leung, Singapore (SG)

(21) Appl. No.: 19/376,875

(22) Filed: Oct. 31, 2025

Related U.S. Application Data
(63) Continuation-in-part of application No. PCT/SG2024/050431, filed on Jul. 7, 2024.

(51) Int. Cl. F24S 20/20; F24S 23/30; F24S 23/71

(52) U.S. Cl. CPC F24S 20/20; F24S 23/31; F24S 23/71; F24S 2020/23

(57) ABSTRACT

In general terms the present invention proposes a device for harvesting renewable energy. The device comprises a wind turbine, a channel for directing wind to the wind turbine, and a solar receiver positioned in the channel for receiving sunlight entering the channel.

### CROSS-REFERENCE TO RELATED APPLICATIONS

This application is a continuation in part of application of PCT/SG2024/050431, filed on Jul. 7, 2024, which claims the benefit of Singapore patent application No. 10202301882Y, filed on Jul. 7, 2023, the contents of which are incorporated by reference in their entirety.

### BACKGROUND

### Field of the Invention

This invention relates to the utilization of renewable resources to generate energy. In particular, though not exclusively, this invention relates to a device for harvesting renewable energy, a system for storing energy comprising the device, and a building having the device installed thereon.

### Scope of the Prior Art

Global concern about electrical consumption and environmental sustainability has prompted the application of renewable energy sources in buildings. As the world population, at large, continues to migrate to cities, buildings are being built to increasing heights. In high-rise buildings, rooftops are typically used to install photovoltaic (PV) systems. However, as buildings are becoming taller, the available roof space per living unit is no longer adequate to meet the energy demand of buildings.

While PV or solar hot water (SHW) panels can be directly integrated into building façades, such strategies remain relatively unpopular, due to the lower solar intensity received on the vertical sides of buildings. Coupled with the high cost of PV and SHW panels, which means longer return on investments, such solutions have remained unpopular in high-rise buildings. There remains a need for improved renewable energy systems that can generate electricity, heated water, and provide enhancement of thermal performance. It is an object of the invention to address at least one of the above problems, or another problem associated with the prior art.

### SUMMARY

A first aspect of the invention provides an energy harvesting device comprising: a wind turbine; a channel for directing wind to the wind turbine; and a solar receiver positioned in the channel for receiving sunlight entering the channel.

Suitably, the solar receiver may be positioned on an internal of the channel.

It has now been found that sunlight striking a solar receiver within a wind directing channel can heat air present in the channel. This can create an area of low pressure in the channel to help accelerate air in the channel towards the wind turbine. Advantageously, more energy may therefore be generated by the wind turbine for a given wind speed, and the wind turbine may be capable of generating energy at even lower wind speeds.

In an embodiment, the channel directs wind to a plurality of wind turbines of the device, and optionally comprises a plurality of solar receivers. The presence of a plurality of wind turbines, and optionally solar receivers, advantageously increases the amount of energy that can be generated by the energy harvesting device.

The channel may have a length defined by the path taken by wind from an opening of the channel to the wind turbine and a width that is transverse to the length. Suitably, the channel may be elongated in width. Conveniently, the presence of a channel elongated in width means that the energy harvesting device itself may be generally elongated in shape and can readily encompass a plurality of wind turbines and/or solar receivers if desired. This may advantageously facilitate installation of the energy harvesting device on building façades or the like. For example, a generally elongated energy harvesting device may be installed on the façade of a building in a horizontal position above or below a window, or in a vertical position alongside a window.

To further enhance the efficiency of the device, in an embodiment, the energy harvesting device may comprise a solar concentrator for directing sunlight to the solar receiver. The solar concentrator may, for example, comprise a lens for focusing sunlight onto the solar receiver. Suitably, the solar concentrator may comprise a Fresnel lens. By directing and/or focusing sunlight onto the solar receiver, the amount of energy that can be generated by the energy harvesting device can be advantageously increased.

In order to maximize the amount of sunlight received by the solar receiver, the solar receiver may be positioned at a suitably determined distance (d) from the solar concentrator. For example, the solar receiver may be positioned at a distance (d) from the solar concentrator such that the amount of sunlight directed to the solar receiver by the solar concentrator is near or at a maximum when the solar concentrator is generally perpendicular (i.e. at an angle of 90°) to the incident angle of the sun's rays.

Due to the changing Azimuth angle of the sun as it moves through the sky throughout the day, the incident angle of the sun's rays striking the solar concentrator may vary throughout the day. Therefore, the optimum distance (d) between the solar receiver and solar concentrator for maximizing the amount of sunlight directed to the solar receiver by the solar concentrator may also vary throughout the day.

Thus, in some embodiments, the solar receiver and solar concentrator may be moveable relative to each other to vary the distance (d) between the solar receiver and solar concentrator. For example, when the solar concentrator is at an angle of less than (or more than) 90° to the incident angle of the sun's rays, the distance (d) may be shortened to maximize the amount of sunlight received by the solar receiver. In this way, the amount of energy that can be generated by the energy harvesting device throughout the day may advantageously be increased.

Suitably, the solar receiver may be moveable between a first position in the channel and a second position in the channel to vary the distance (d) between the solar receiver and solar concentrator.

To help increase the amount of sunlight received by the solar receiver throughout the day, the channel bearing the solar receiver (or indeed the device as a whole) may be rotatable about at least one axis, thereby allowing the channel to follow the movement of the sun in a single plane. Suitably, the channel bearing the solar receiver (or the device as a whole) may be rotatable about at least two axes, thereby allowing the channel to follow the movement of the sun throughout the day in two directional planes (e.g. both horizontally and vertically according to the sun path).

In some embodiments, the wind turbine may comprise an axis of rotation generally perpendicular to wind flow therethrough (i.e. to wind flow through the energy harvesting device, for example through the channel of the energy harvesting device). In certain environments, orientating the wind turbine in this manner can allow greater torque to be generated by the wind turbine, thus resulting in increased power output.

Alternatively, the wind turbine may comprise an axis of rotation generally parallel to wind flow therethrough (i.e. to wind flow through the energy harvesting device, for example through the channel of the energy harvesting device).

In an embodiment, the energy harvesting device may comprise an elongate trough defining the channel. The trough may be elongate in length, i.e. extending along a longitudinal length greater than its width or depth. Suitably the trough may comprise a base, first and second elongate sides and an opening. Optionally, the trough may comprise first and/or second ends. One or both of the ends may be capped by an end wall. Suitably, the wind turbine may comprise an axis of rotation generally parallel to the longitudinal length of the trough. In such embodiments, the length of the wind turbine along its axis of rotation may be greater than or equal to 80% of the longitudinal length of the trough, or greater than or equal to 90% of the longitudinal length of the trough, optionally greater than or equal to 95% of the longitudinal length of the trough. In this way, the wind catchment area of the wind turbine can be maximized, thereby increasing the efficiency of the wind turbine.

Furthermore, when the wind turbine comprises an axis of rotation generally parallel to the longitudinal length of the trough, it may be possible to couple the wind turbine to one or more generators at the first and/or second ends of the trough. Thus, the remainder of the trough can be made available for wind catchment, thereby allowing greater torque to be generated by the wind turbine. This can be of particular advantage, for example, in consistently windy environments.

The wind turbine (or a plurality of wind turbines) may be positioned in the base of the trough. In this manner, the first and second elongate sides form a channel for directing wind from the opening to the one or more wind turbines. Conveniently, the one or more wind turbines may be mounted within a generally elongate slot (i.e. a narrow opening or slit) in the base. Alternatively, the one or more wind turbines may optionally be mounted within one or more apertures in the base.

In some embodiments, the device may comprise: two wind turbines each comprising an axis of rotation generally parallel to the longitudinal length of the trough; and a generator, wherein the wind turbines are separated from each other by the generator. Suitably, the wind turbines may be arranged such that their axes of rotation are aligned head to tail longitudinally along generally the same axis. Conveniently, the two wind turbines and generator may be mounted within a generally elongate slot in the base of the trough.

In some embodiments, the device may comprise: a plurality of wind turbines each comprising an axis of rotation generally parallel to the longitudinal length of the trough; and one or more generators, wherein the plurality of wind turbines are separated from one another by the one or more generators. Suitably, the wind turbines may be arranged such that their axes of rotation are aligned head to tail longitudinally along generally the same axis. Conveniently, the plurality of wind turbines and one or more generators may be mounted within a generally elongate slot in the base of the trough.

For example, the device may comprise: two wind turbines each comprising an axis of rotation generally parallel to the longitudinal length of the trough; and two generators, wherein the wind turbines and generators are arranged alternating in series (i.e. wind turbine-generator-wind turbine-generator) along the longitudinal length of the trough.

Utilizing two or more wind turbines each comprising an axis of rotation generally parallel to the longitudinal length of the trough may allow smaller rating generators (i.e. that require lower wind speed and torque) to be used to generate energy. This can optimize energy generation by the energy harvesting device in, for example, environments where the wind speed is low.

Alternatively, the wind turbine (or a plurality of wind turbines) may comprise an axis of rotation generally perpendicular to a longitudinal length of the trough. In some embodiments, one or more solar receivers are positioned on the first side of the trough. Suitably, in such embodiments, the second side of the trough may advantageously comprise one or more solar concentrators. This arrangement allows sunlight to be directed and/or concentrated across the channel onto the one or more solar receivers mounted on the first side of the trough inside the channel. Advantageously, this can result in air in the channel being warmed by the sunlight directed and/or concentrated across the channel, thereby creating an area of low pressure in the channel. As aforementioned, this can accelerate air in the channel towards the wind turbine.

In some embodiments, the first side of the trough may comprise a first solar concentrator and the second side of the trough may comprise a second solar concentrator. Suitably, in such embodiments, one or more solar receivers may be positioned in the channel for receiving sunlight from the first and/or second solar concentrators.

For example, the device may comprise a solar receiver positioned in the channel for receiving sunlight from both the first and second solar concentrators. Alternatively, the device may comprise a first solar receiver positioned in the channel for receiving sunlight from the first solar concentrator, and a second solar receiver positioned in the channel for receiving sunlight from the second solar concentrator.

Such arrangements may be particularly advantageous, for example, when trough of the energy harvesting device (or indeed the device as a whole) is positioned such that its longitudinal length is generally North-South orientated. Thus, when the sun is generally in the East, incident sunlight may, for example, strike the first solar concentrator, and when the sun is generally in the West, incident sunlight may, for example, strike the second solar concentrator.

In this way, sunlight may be directed and/or concentrated across the channel from the first and/or second solar concentrators onto the one or more solar receivers throughout the day as the sun moves across the sky (i.e. East or West). This can increase the amount of sunlight entering the trough, and therefore received by the one or more solar receivers throughout the day.

Suitably, the trough of the energy harvesting device (or indeed the device as a whole) may be rotatable about an axis running generally along the longitudinal length thereof. Thus, if the energy harvesting device is attached to a surface (e.g. a building façade) so that the longitudinal length of the trough is substantially parallel to the Earth's surface, the trough may be rotated up or down about its longitudinal axis to follow the movement of the sun as it rises and falls in the sky throughout the day. This can advantageously increase the amount of sunlight entering the trough, and therefore received by the solar receiver throughout the day.

Suitably, the trough of the energy harvesting device may be rotatable about an axis generally orthogonal to the longitudinal length thereof. Thus, if the energy harvesting device is attached to a surface (e.g. a building façade) the trough may be rotated clockwise or anticlockwise relative the surface to follow the movement of the sun as it moves across the sky (i.e. East or West) throughout the day. This can advantageously increase the amount of sunlight entering the trough, and therefore received by the solar receiver throughout the day.

Advantageously, the trough (or the energy harvesting device as a whole) may be rotatable about an axis running generally along the longitudinal length thereof and rotatable about an axis generally orthogonal to the longitudinal length thereof, thereby allowing the trough to follow the movement of the sun throughout the day in two directional planes (e.g. both horizontally and vertically according to the sun path).

The solar receiver may be any device suitable for receiving solar radiation to facilitate its use as energy. Suitably, the solar receiver may be arranged to convert solar radiation to electrical and/or thermal energy. The solar receiver may, for example, comprise a photovoltaic (PV) cell and/or a solar thermal panel (e.g. solar hot water or through-pass air). The solar receiver may comprise one or more secondary solar concentrators. Suitable solar receivers are known in the art.

In embodiments where the solar receiver is a PV cell, the movement of air through the channel towards the wind turbine can create a flow of air over the PV cell, thereby cooling it. It is known that the performance of PV cells decreases as the temperature of a PV cell increases (see, for example, Zubeer, S. A. et. al. 2017, E3S Web of Conferences, 22, 00205). Therefore, this cooling of the PV cell by air flowing through the channel advantageously results in improved performance of the PV cell, and hence increases the energy output of the energy harvesting device.

Suitably, energy harvested by the wind turbine and/or the solar collector may be converted to electricity.

Advantageously, the energy harvesting device may be oriented or mounted such that the channel leads upwardly to the wind turbine. In particular, the channel may lead from an opening having a relatively lower position to the wind turbine having a relatively higher position. Such orientation or positioning of the device advantageously facilitates heated air flow through the wind turbine, enhancing efficiency.

The term “wind turbine” is used herein to refer to any device capable of capturing the kinetic energy of wind, suitably by converting it into a more readily usable form of energy, for example, electrical energy or heat energy. Suitably, a wind turbine may comprise at least one blade attached to a shaft. When wind flows across the blade, the air pressure on one side of the blade decreases. The difference in air pressure across the two sides of the blade creates both lift and drag forces. When the lift force is stronger than the drag force, the blade rotates about its axis, resulting in rotation of the shaft to generate mechanical energy, which can be used directly or further converted into other forms of energy.

For example, mechanical energy may be converted into electrical energy by a generator. The term “generator” is used herein to refer to any device capable of converting mechanical energy into electrical energy for use in an electrical circuit.

A second aspect of the invention provides a system for storing energy comprising: a device according to a first aspect of the invention; and a phase change material (PCM), the system being configured to transfer heat energy harvested by the device from the device to the PCM.

A wide range of PCMs are known in the art (see, for example, Heat and Cold Storage with PCM, Mehling, H; Cabeza, L. F, ISBN: 978-3-540-68556-2). PCMs can be used to store heat i.e. thermal) energy by causing a change in the “state” or “phase” of the PCM, for example from a solid to a liquid.

The PCM may comprise an organic material such as a paraffin or a paraffin-derived hydrocarbon, a carbohydrate, a lipid, or a mixture thereof. Non-limiting examples of suitable organic materials include n-tetradecane (C-14), n-hexadecane (C-16), and noctadecane (C-18) and olefin.

Alternatively or additionally, the PCM may comprise an inorganic material such as an inorganic salt hydrate or eutectic material. Non-limiting examples of suitable inorganic materials include calcium chloride hexahydrate, glauber salt, Na2SO4·10H2O, CaCl2·6H2O, NaHPO4·12H2O, Na2S2O3·5H2O and NaCO3·10H2O.

In an embodiment, the PCM may form part of a refrigeration cycle, for example, to provide air conditioning. Refrigeration cycles are known in the art, and typically comprise a compressor, a condenser, an expansion valve or device, and an evaporator. These four components work together to remove heat from one area (e.g. a room in a building) and expel the removed heat in another area (e.g. the space outside a building). Heat energy harvested by the device and absorbed by the PCM may advantageously be used offset the energy requirements of the compressor.

A third aspect of the invention provides a building having installed thereon an energy harvesting device according to the first aspect of the invention or an array of energy harvesting devices according to the first aspect of the invention.

The energy harvesting device(s) may suitably be installed on a façade of the building. The building may advantageously be arranged to utilize solar and/or wind energy harvested by the energy harvesting device(s).

Also envisaged herein is a method of enhancing the efficiency of a wind turbine, the method comprising: channeling wind to the wind turbine through a channel comprising, a solar receiver for receiving sunlight entering the channel.

Suitably, the method may comprise: channeling wind to the wind turbine through a channel comprising, mounted on an internal thereof, a solar receiver for receiving sunlight entering the channel.

The method may comprise the step of rotating a trough defining the channel to enhance solar irradiation of the solar receiver.

Throughout the description and claims of this specification, the words “comprise” and “contain” and variations of the words, for example “comprising” and “comprises”, mean “including but not limited to”, and do not exclude other components, integers or steps.

Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 is a perspective view of an energy harvesting device in accordance with a first embodiment of the invention having four vertical axis wind turbines.

FIG. 2 is a cross sectional view of the energy harvesting device of FIG. 1 showing wind directed to a wind turbine and light propagating to a solar receiver.

FIG. 3 is a perspective view of an energy harvesting device in accordance with a second embodiment of the invention having a horizontal axis wind turbine.

FIG. 4 is a cross sectional view of the energy harvesting device of FIG. 3 showing wind directed to the wind turbine and light propagating to a solar receiver.

FIG. 5 is a perspective view of an energy harvesting device in accordance with a third embodiment of the invention having a horizontal axis wind turbine and a solar receiver connected to an internal tracking mechanism.

FIG. 6A is a cross sectional view of the energy harvesting device of FIG. 5 showing wind directed to the wind turbine and light propagating to the solar receiver in a first position.

FIG. 6B is a cross sectional view of the energy harvesting device of FIG. 5 showing wind directed to the wind turbine and light propagating to the solar receiver in a second position.

FIG. 7 is a perspective view of a dual lens energy harvesting device in accordance with a fourth embodiment of the invention having a horizontal axis wind turbine.

FIG. 8 is a cross sectional view of the dual lens energy harvesting device of FIG. 7 showing wind directed to the wind turbine and light propagating to a solar receiver.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

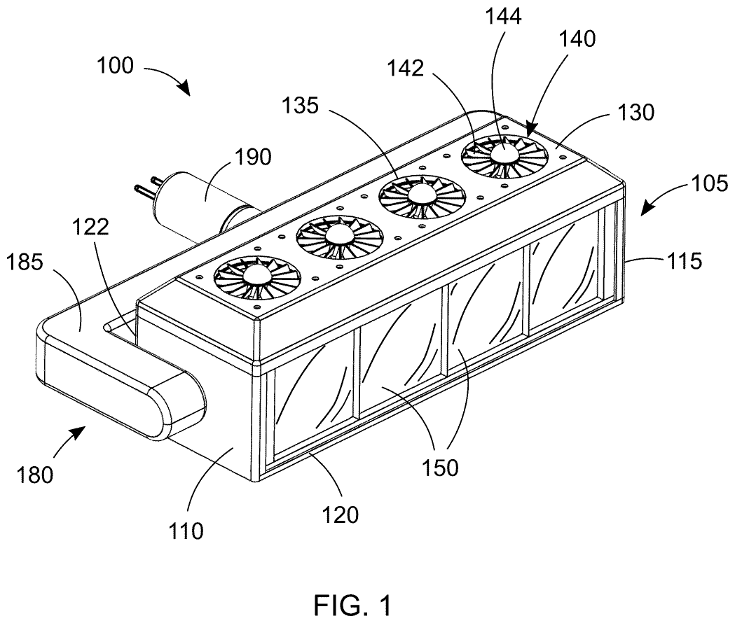

Referring to FIG. 1, an energy harvesting device 100 according to a first embodiment of the invention comprises an elongated trough 105 attached to a mount 180. The mount comprises an arm portion 185 which is attached to opposing first and second end walls 110, 115 of the trough 105. In an embodiment, the trough 105, the first 110 and second 115 end walls, the solar concentrators 150 that comprise the first 120 and second 122 sides of the trough 105, and any supporting structures such as the arm portion 185, are considered part of the frame. The trough 105, the first 110 and second 115 end walls, and the solar concentrators 150 that comprise the first 120 and second 122 sides of the trough 105, define a channel to direct wind upwards. The arm portion 185 is attached to an actuator 190 which can rotate the arm portion 185 clockwise or anticlockwise about its axis. The actuator 190 may suitably be attached to the façade of a building (not shown). The arm portion 185 can rotate the trough 105 about its longitudinal axis. As shown, the trough 105, a portion of the frame, or the entire frame, is rotatable about an axis parallel with the horizon. In another embodiment, the trough 105, a portion of the frame, or the entire frame, is rotatable about an axis perpendicular to the horizon.

As will be discussed in more detail below, the trough 105 comprises a first side 120, a second side 122, and a base portion 130. The ends of the first and second sides 120, 122 are capped by first and second end walls 110, 115. The base portion 130 has four apertures 135, inside each of which sits a vertical axis Savonius-type wind turbine 140. Each wind turbine 140 has a set of blades 142 attached to a rotor shaft 144. The first side 120 of the rough 105 is made up of four Fresnel lenses 150, which are arranged to direct and focus incident sunlight into the trough 105.

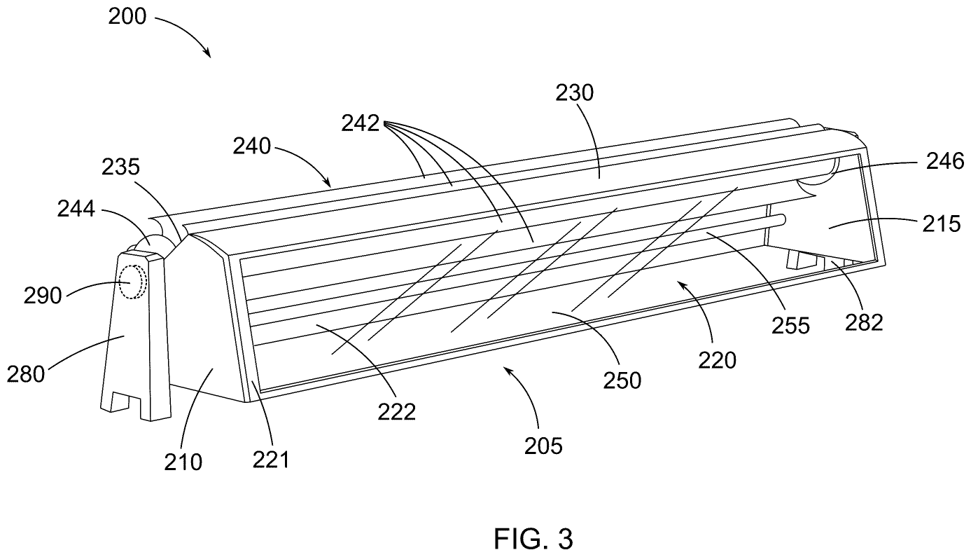

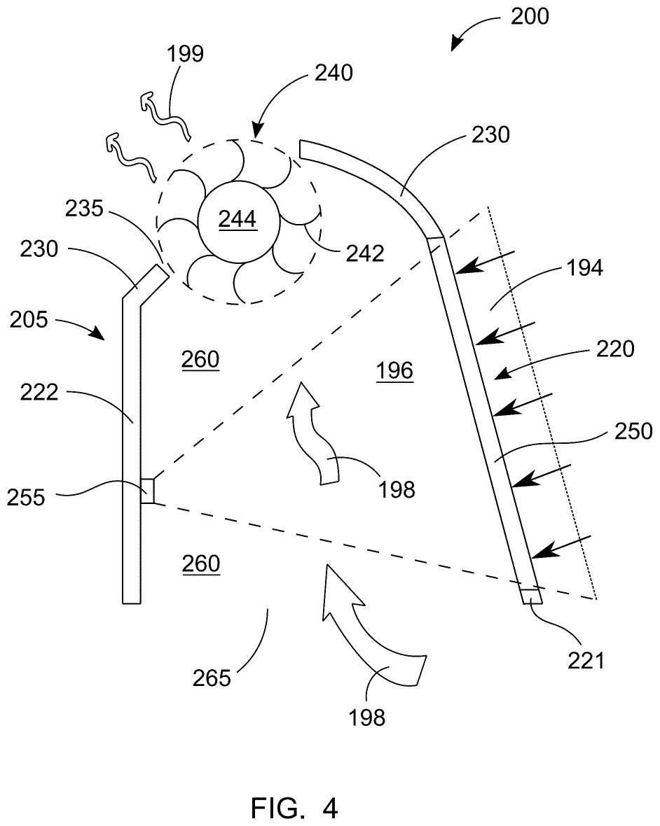

It should be appreciated that the four Fresnel lenses 150 can be replaced by a singular, elongated Fresnel lens or any other arrangement of Fresnel lenses having the same solar focusing effect. These Fresnel lenses 150 work as a solar concentrator, redirecting any sunlight passing through the lenses onto the solar receiver (255 in FIGS. 3-4).

It should be appreciated that the solar concentrator can be any component that focuses sunlight onto a solar receiver, including, but not limited to, parabolic throughs, Fresnel reflectors, linear Fresnel reflectors, parabolic dishes, heliostats, Fresnel lenses, linear Fresnel lenses, compound parabolic concentrators, v-trough concentrators, or any combination thereof.

It should be appreciated that the solar concentrator(s) can be configured to focus incident sunlight into a linear focal region such as a linear solar receiver. For example, in FIG. 3, the Fresnel lens 250 is configured to focus incident sunlight onto the long and narrow solar receiver 255.

The maximum linear dimension of the solar concentrator is the longest straight line that can be measured from one end of the solar concentrator to the other end, encompassing its largest length or width. For example, in FIG. 1, the maximum linear dimension of the solar concentrator (the Fresnel lenses 150) runs parallel to the horizon, approximately from the first wall 110 to the second wall 115.

The maximum linear dimension of a solar receiver is the longest straight line that can be measured from one end of the solar receiver to the other end, encompassing its largest length or width. For example, in FIG. 3, the maximum linear dimension of the solar receiver 255 runs parallel to the horizon, approximately from the first wall 210 to the second wall 215.

In an embodiment, the maximum linear dimension of the solar concentrator and solar receiver is oriented horizontally or substantially horizontally (e.g., such as in FIG. 1).

In another embodiment, the maximum linear dimension of the solar concentrator and solar receiver is oriented vertically (e.g. such as in FIG. 9). In this ‘solar chimney’ embodiment, the wind turbine can be located at the top edge of the device (e.g., on the higher side of trough) such that air flows through the entire channel before reaching the wind turbine.

In yet another embodiment, the maximum linear dimension of the solar concentrator and solar receiver is oriented at least 30 degrees from the horizon, more preferably at least 45 degrees from the horizon, even more preferably at least 60 degrees from the horizon, and most preferably at least 75 degrees from the horizon. In this hybrid embodiment, the wind turbine can be located at the top edges of the device (e.g., on the higher sides of the trough) such that air flows through at least a portion of the channel before reaching the wind turbine.

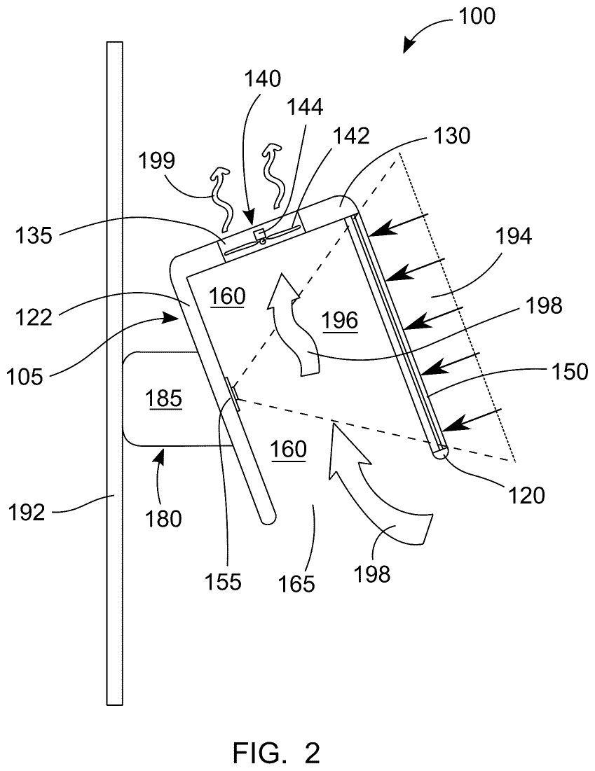

Referring now to FIG. 2, which provides a cross sectional view of the energy harvesting device 100 of FIG. 1, the trough 105 and the solar concentrators 150 that comprise the first 120 and second 122 sides of the trough 105 define a channel 160 having an opening 165. The trough 105 is installed on the façade of a building 192 so that its longitudinal axis is horizontal with respect to the ground (not shown). For example, the solar concentrator 150 may be installed on the façade of a building 192 in a horizontal position above a window.

Incident sunlight 194 enters the trough 105 via the Fresnel lenses 150 in the first side 120 of the trough 105, to provide concentrated sunlight 196 inside the channel 160. Concentrated sunlight 196 is directed and focused by the Fresnel lenses 150 onto a solar receiver 155 positioned on the second side 122 of the trough 105, inside the channel 160. The solar receiver 155 can convert the received concentrated sunlight 196 into electrical or heat energy for use in the building 192 to which it is attached.

The concentrated sunlight 196 also increases the temperature of air in the channel 160. This creates an area of low pressure within the channel 160, which draws wind 198 through the channel 160 and accelerates it towards the wind turbine 140. Wind 198 flows across the blades 142 of the wind turbine 140, through the aperture 135, causing the blades 142 to rotate about their axis. This results in rotation of the shaft 144 to generate mechanical energy, which can be converted into electrical or heat energy for use in the building 192 to which it is attached. Wind 198 exits the aperture 135 of base portion 130 as a stream of exhaust air 199.

Referring to FIG. 3, an energy harvesting device 200 according to a second embodiment of the invention comprises an elongated trough 205 connected to first and second support stands 280, 282.

The first and second support stands 280, 282 are connected to opposing first and second end walls 210, 215 of the trough 205. A tracking motor 290 (shown in dashed lines) concealed within the first support stand 280 can rotate the trough 205 clockwise or anticlockwise about its longitudinal axis to track the movement of the sun across the sky throughout the day. The first and second support stands 280, 282 may suitably be attached to the roof or façade of a building (not shown).

The trough 205 comprises a first side 220, a second side 222, and a base portion 230. The ends of the first and second sides 220, 222 are capped by first and second end walls 210, 215. The base portion 230 has an elongate slot 235, in which sits a horizontal axis wind turbine 240. The wind turbine 240 has a set of blades 242 attached to a rotor shaft 244. One end of the rotor shaft is attached to a generator 246, which converts the mechanical energy from the rotation of the rotor shaft 244 into electrical energy.

The first side 220 of the trough 205 comprises a frame 221 which secures in place a rectangular Fresnel lens 250. The Fresnel lens 250 is of similar length and width to the first side 220 of the trough 205, and hence occupies a significant proportion of the area of the first side 220. The Fresnel lens 250 is arranged to direct and focus incident sunlight into the trough 205 and onto a solar receiver 255. The solar receiver 255 is positioned inside the trough 205 on the second side 222. The solar receiver 255 is equal in length to the longitudinal length of the trough 205, and runs along the second side 222 from the first end wall 210 to the second end wall 215.

Referring now to FIG. 4, which provides a cross sectional view of the energy harvesting device 200 of FIG. 3, the trough 205 defines a channel 260 having an opening 265.

Incident sunlight 194 enters the trough 205 via the Fresnel lens 250 in the first side 220 of the trough 205, to provide concentrated sunlight 196 inside the channel 260. Concentrated sunlight 196 is directed and focused by the Fresnel lens 250 onto the solar receiver 255 positioned on the second side 222 of the trough 205, in the channel 260. The solar receiver 255 can convert the received concentrated sunlight 196 into electrical or heat energy for use in a building to which it is attached (not shown).

The concentrated sunlight 196 also increases the temperature of air in the channel 260. This creates an area of low pressure within the channel 260, which draws wind 198 through the channel 260 and accelerates it towards wind turbine 240. Wind 198 flows across the blades

242 of the wind turbine 240, and out through the elongate slot 235, causing the blades 242 to rotate about their axis. This results in rotation of the shaft 244 to generate mechanical energy, which can be converted into electrical or heat energy. Wind 198 exits the elongate slot 235 of base portion 230 as a stream of exhaust air 199.

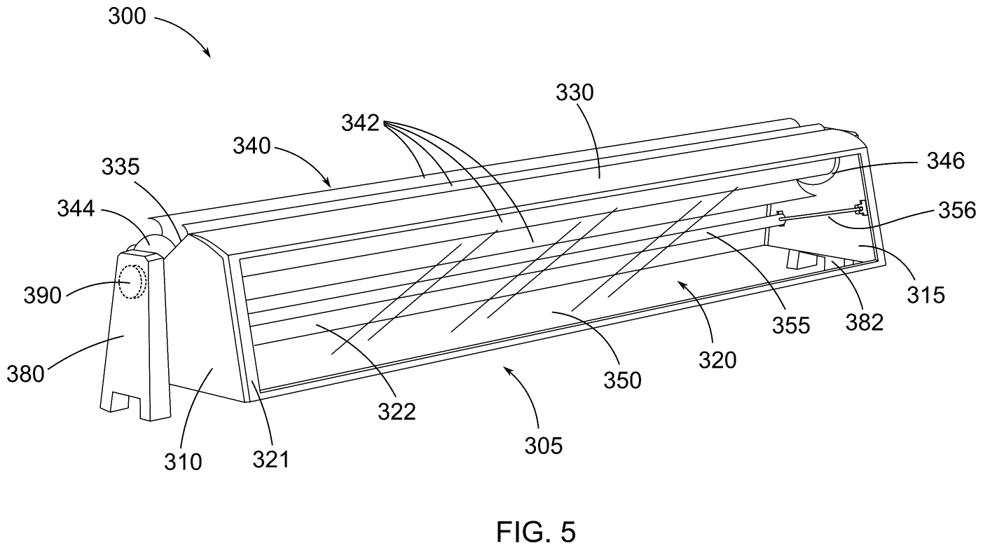

Referring to FIG. 5, an energy harvesting device 300 according to a third embodiment of the invention comprises an elongate trough 305 connected to first and second support stands 380, 382.

The first and second support stands 380, 382 are connected to opposing first and second end walls 310, 315 of the trough 305. A tracking motor 390 (shown in dashed lines) concealed within the first support stand 380 can, continuously or periodically, rotate the trough 305 about its longitudinal axis to track the movement of the sun across the sky throughout the day such that a path of the sunlight remains orthogonal to an outer surface of the solar concentrator 350. The first and second support stands 380, 382 may suitably be attached to the roof or façade of a building (not shown).

The trough 305 comprises a first side 320, a second side 322, and a base portion 330. The ends of the first and second sides 320, 322 are capped by first and second end walls 310, 315. The base portion 330 has an elongated slot 335, in which sits a horizontal axis wind turbine 340. The wind turbine 340 has a set of blades 342 attached to a rotor shaft 344.

One end of the rotor shaft is attached to a generator 346, which converts the mechanical energy from the rotation of the rotor shaft 344 into electrical energy. The first side 320 of the trough 305 comprises a frame 321 which secures in place a rectangular Fresnel lens 350. The Fresnel lens 350 is of similar length and width to the first side 320 of the trough 305, and hence occupies a significant proportion of the area of the first side 320. The Fresnel lens 350 is arranged to direct and focus incident sunlight into the trough 305 and onto a solar receiver 355.

The solar receiver 355 is equal in length to the longitudinal length of the trough 305 and runs along the second side 322 from the first end wall 310 to the second end wall 315. The solar receiver 355 is connected to an internal tracking mechanism 356, which is attached to the second end wall 315. The internal tracking mechanism 356 moves the solar receiver 355 from the second side 322 into the trough 305 towards the first side 320 (and back again) throughout the day as the Azimuth angle of the sun relative to the Fresnel lens 350 changes, as explained below.

The internal tracking mechanism 356 is designed to dynamically reposition the solar receiver 355 along a linear path between the Fresnel lens 350 and the base of the trough 305, thereby optimizing the alignment of the receiver with the focal point of the concentrated sunlight 196. This linear path can correspond to a z-axis, which is perpendicular to the plane of the Fresnel lens.

In one implementation, the tracking mechanism may comprise a motorized screw drive, such as a lead screw or ball screw system. In this configuration, the solar receiver 355 is mounted to a carriage or platform threaded onto the screw shaft. As the screw rotates, driven by an electric motor such as a stepper or servo motor, the carriage moves linearly forward or backward, adjusting the distance between the receiver and the Fresnel lens. This approach provides high positional accuracy and load-bearing stability, which are advantageous for larger or heavier receivers.

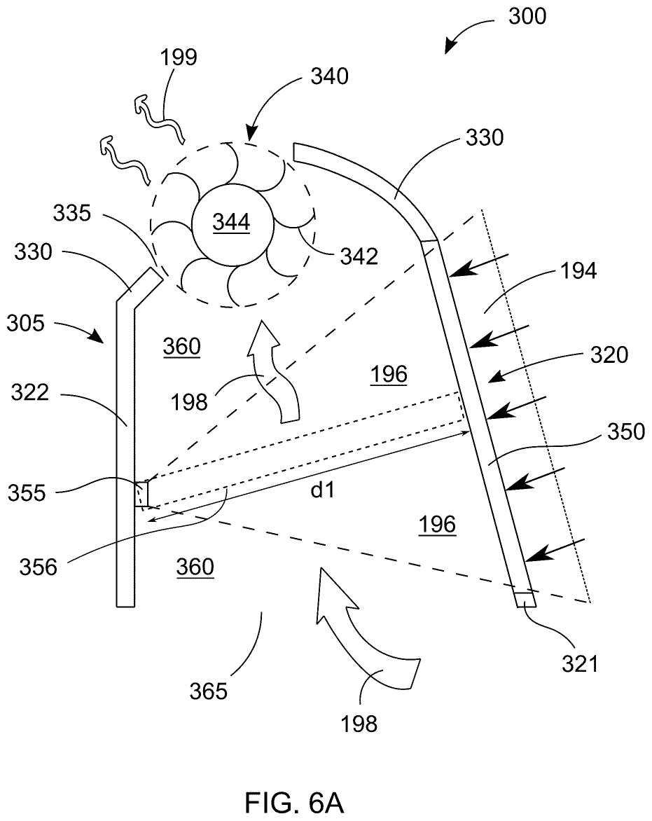

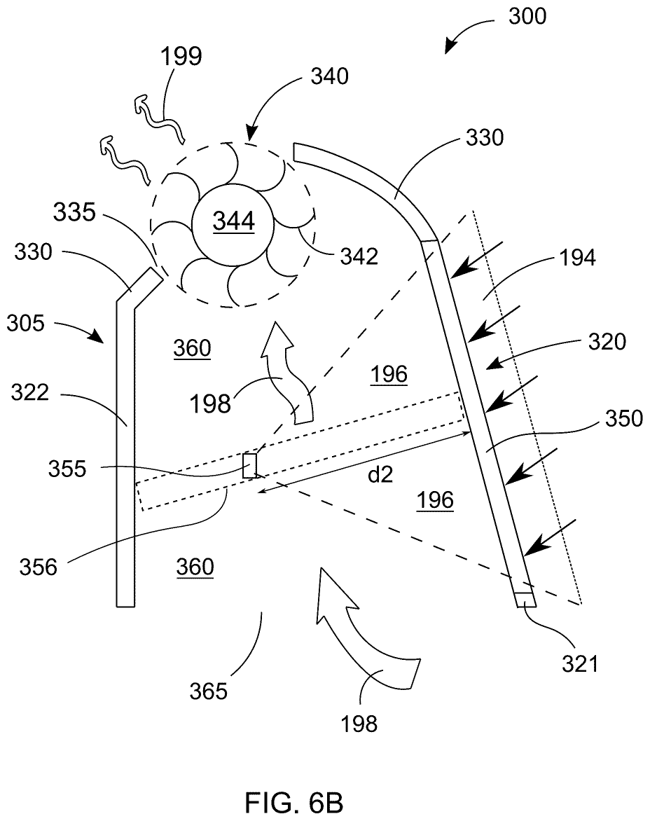

Another configuration employs a rail system in which the receiver is mounted on a sliding carriage that travels along precision guide rails (e.g. the internal tracking mechanism 356, illustrated in broken lines in FIGS. 6A-6B, can be a rail and carriage system having a belt and pulley system to drive the receiver 355 towards and away from the Fresnel lens 350). The receiver can be driven by a belt-and-pulley system, rack-and-pinion assembly, or directly by stepper motors with integrated linear motion capabilities. This system can be programmed to follow a pre-defined sun-tracking algorithm that maps expected focal point positions throughout the day based on geographic coordinates, time of year, and solar angles.

Referring now to FIG. 6A, which provides a cross sectional view of the energy harvesting device 300 of FIG. 5, the trough 305 defines a channel 360 having an opening 365. The solar receiver 355 is positioned in the channel 360 in a first position on the second side 322 of the trough 305. In the first position, the solar receiver 355 is located at a distance d1 from the Fresnel lens 350.

Incident sunlight 194 enters the trough 305 via the Fresnel lens 350, to provide concentrated sunlight 196 inside the channel 360. When rays of the incident sunlight 194 are perpendicular (i.e. at an angle of 90°) to the plane of the Fresnel lens 350, as shown in FIG. 6A, the Fresnel lens 350 directs and focuses the concentrated sunlight 196 towards a focal point at a distance d1 away from the Fresnel lens 350 in the channel 360.

Hence, when rays of the incident sunlight 194 strike the Fresnel lens 350 such that they are perpendicular to the plane of the Fresnel lens 350, the amount of concentrated sunlight 196 received by the solar receiver 355 is at a maximum when the solar receiver 355 is in the first position at a distance d1 from the Fresnel lens 350.

Referring now to FIG. 6B, as the sun moves through the sky throughout the day, the Azimuth angle of the sun changes. This causes rays of the incident sunlight 194 strike the Fresnel lens 350 at an angle less than 90° to the plane of the Fresnel lens 350. When the sun is at its highest point in the sky, the Fresnel lens 350 directs and focuses the concentrated sunlight 196 towards a focal point at a distance d2 away from the Fresnel lens 350 in the channel 360.

In order to maximize the amount of concentrated sunlight 196 received by the solar receiver 355, the internal tracking mechanism 356 moves, continuously or periodically, the solar receiver 355 from the first position at a distance d1 from the Fresnel lens 350 to a second position at a distance d2 from the Fresnel lens 350, as shown in FIG. 6B.

As the sun descends from its highest point in the sky, and the angle at which rays of the incident sunlight 194 strike the plane of the Fresnel lens 350 gradually returns to 90°, the internal tracking mechanism 356 gradually moves the solar receiver 355 from the second position at a distance d2 from the Fresnel lens 350 back to the first position at a distance d1 from the Fresnel lens 350, as shown in FIG. 6A.

It should be appreciated that the frame can facilitate a variation of the perpendicular distance between the solar concentrator and solar receiver. This can be achieved by 1) allowing the solar receiver to move towards and away from the solar concentrator, where the solar concentrator is fixed in place relative to the frame (e.g., such as the embodiment of FIGS. 6a-6b), 2) allowing the solar concentrator to move towards and away from the solar receiver, where the solar receiver is fixed in place relative to the frame, or 3) allowing the solar receiver and solar concentrator to move towards and away from each other, where neither the solar receiver nor the solar concentrator are fixed in place relative to the frame. If the solar receiver or solar concentrator is fixed in place relative to the frame, the device advantageously receives less wear and tear due to having fewer moving parts.

In an embodiment, the frame does not facilitate the motion of the solar concentrator and/or solar receiver orthogonal to the perpendicular distance between the solar concentrator and solar receiver (e.g., if the solar concentrator and solar receiver move towards and away from each other along the z-axis, the solar concentrator and solar receiver cannot move along the x and y axes). Limiting the motion of the solar receiver and solar concentrator along the perpendicular distance between the solar receiver and solar concentrator provides two advantages: 1) The size of the device can be smaller and 2) the amount of wear and tear will be lower.

As used herein, ‘opposing first and second structural walls of the energy-harvesting device’ denote the inner surfaces that bound the receiver's travel path along the perpendicular (z-axis): the incident-side wall that carries or adjoins the solar concentrator, and the opposing wall or base on the receiver side of the channel. The “perpendicular distance” is measured along a normal from the incident-facing surface of the solar concentrator to the opposing structural wall.

In certain embodiments, the internal tracking mechanism provides a receiver stroke that spans at least 25% of the perpendicular distance between the opposing structural walls, and in further embodiments at least 40%, at least 50%, at least 60%, at least 75%, substantially the full distance (≥90%), of the full distance (100%). This quantified stroke allows the focal region to be maintained on the receiver across large variations in solar incidence angle due to time-of-day and seasonal changes, while preserving compact device depth.

In certain embodiments, the stroke limits may be enforced mechanically (e.g., hard stops on rails or lead-screw end blocks) and/or electronically (e.g., encoder-based soft limits), and may be selected by lookup from a geographic/sun-path table or computed in real time from a sun-vector model.

In embodiments optimized for linear focusing, at least one of the solar concentrator and the solar receiver (e.g., a linear Fresnel lens, linear Fresnel reflector, or v-trough as the concentrator), and a linear photovoltaic and/or thermal receiver as the receiver, exhibits a substantially uniform cross-section along its maximum linear dimension. As used here, “substantially uniform” means that cross-sections taken normal to that dimension are consistent in shape within normal manufacturing tolerances, excluding localized discontinuities such as joints between adjacent portions, mounting features, or end fittings. This uniformity promotes even optical flux distribution and predictable thermal management along the receiver.

In embodiments optimized for linear focusing, at least one of the solar concentrator and the solar receiver (e.g., a linear Fresnel lens/reflector or v-trough; a linear PV/thermal receiver) exhibits a substantially uniform cross-section along its maximum linear dimension. “Substantially uniform” indicates that cross-sections taken normal to that dimension are consistent in shape within normal manufacturing tolerances, for example with ≤±10% variation in cross-sectional area and ≤±5% variation in characteristic feature widths, excluding localized discontinuities (e.g., joints between adjacent portions, mounting features, or end fittings). This uniformity promotes even optical flux distribution and predictable thermal management along the receiver.

The frame constrains the solar concentrator and the solar receiver so that their principal planes are substantially parallel during operation (allowing only the controlled variation of perpendicular spacing); this co-planarity preserves focusing geometry and minimizes wedge-induced aberrations as the device tracks the sun.

A control subsystem may command the frame's azimuth/elevation actuators to keep the incident-facing surface of the concentrator substantially perpendicular to incident sunlight (error typically ≤5°), while a secondary loop drives the receiver actuator to a setpoint derived from a focal-distance model. The setpoint may be determined by: (i) precomputed tables keyed by time, date, and latitude/longitude; (ii) a closed-loop optical signal (e.g., quad-cell photodiodes or a line of thermistors on the receiver detecting peak irradiance); or (iii) a hybrid approach. Updates may be continuous or periodic (e.g., every 10-120 s), and the system may apply feed-forward compensation for lens temperature or refractive-index drift.

In façade or tilted installations, the channel is oriented so that air warmed by the redirected sunlight experiences a buoyancy-assisted upwards flow toward the wind turbine. For horizontal orientations the turbine may be placed at the top or bottom of the channel; for tilted or near-vertical orientations (e.g., >45° from the horizon) the turbine is placed at the uppermost side to exploit the chimney effect for enhanced mass flow and torque.

In the energy harvesting device 300, the concentrated sunlight 196 also increases the temperature of air in the channel 360. This creates an area of low pressure within the channel 360, which draws wind 198 through the channel 360 and accelerates it towards wind turbine 340. Wind 198 flows across the blades 342 of the wind turbine 340, and out through the elongate slot 335, causing the blades 342 to rotate about their axis. This results in rotation of the shaft 344 to generate mechanical energy, which can be converted into electrical or heat energy. Wind 198 exits the elongate slot 335 of base portion 330 as a stream of exhaust air 199.

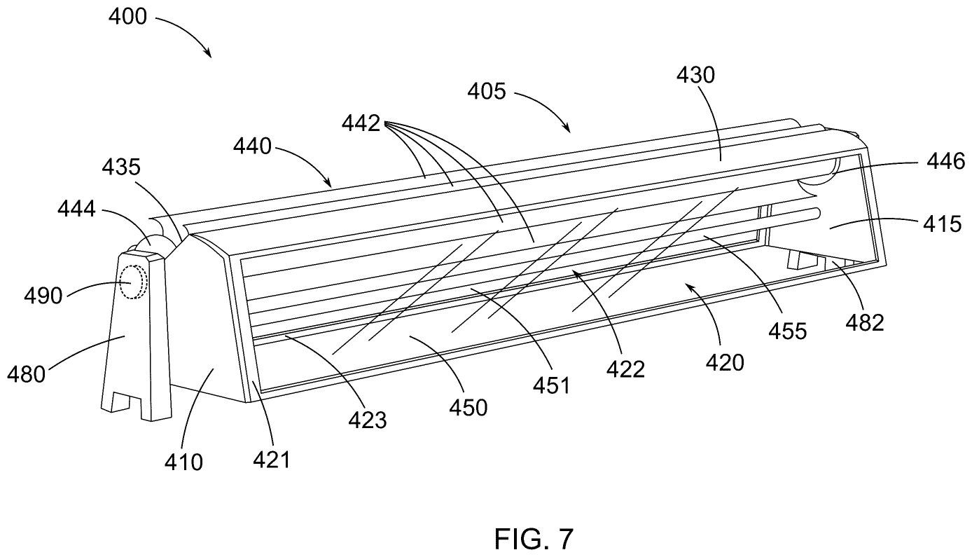

Referring to FIG. 7, an energy harvesting device 400 according to a fourth embodiment of the invention comprises an elongate trough 405 connected to first and second support stands 480, 482.

The first and second support stands 480, 482 are connected to opposing first and second end walls 410, 415 of the trough 405. A tracking motor 490 (shown in dashed lines) concealed within the first support stand 480 can rotate the trough 405 clockwise or anticlockwise about its longitudinal axis to track the movement of the sun across the sky throughout the day. The first and second support stands 480, 482 may suitably be attached to the roof of a building (not shown).

The trough 405 comprises a first side 420, a second side 422, and a base portion 430. The ends of the first and second sides 420, 422 are capped by first and second end walls 410, 415. The base portion 430 has an elongate slot 435, in which sits a horizontal axis wind turbine 440. The wind turbine 440 has a set of blades 442 attached to a rotor shaft 444. One end of the rotor shaft is attached to a generator 446, which converts the mechanical energy from the rotation of the rotor shaft 444 into electrical energy.

The first side 420 of the trough 405 comprises a first frame 421 which secures in place a first rectangular Fresnel lens 450. The first Fresnel lens 450 is of similar length and width to the first side 420 of the trough 405, and hence occupies a significant proportion of the area of the first side 420. The first Fresnel lens 450 is arranged to direct and focus incident sunlight into the trough 405 and onto a solar receiver 455.

The solar receiver 455 is positioned in the middle of the trough 405, halfway between the first and second sides 420, 422. The solar receiver 455 is equal in length to the longitudinal length of the trough 405, and is attached to the first and second end walls 210, 215 at its furthest ends.

The second side 422 of the trough 405 comprises a second frame 423 which secures in place a second rectangular Fresnel lens 451. The second Fresnel lens 451 is of similar length and width to the second side 422 of the trough 405, and hence occupies a significant proportion of the area of the second side 422. Like the first Fresnel lens 450, the second Fresnel lens 451 is also arranged to direct and focus incident sunlight into the trough 405 and onto the solar receiver 455.

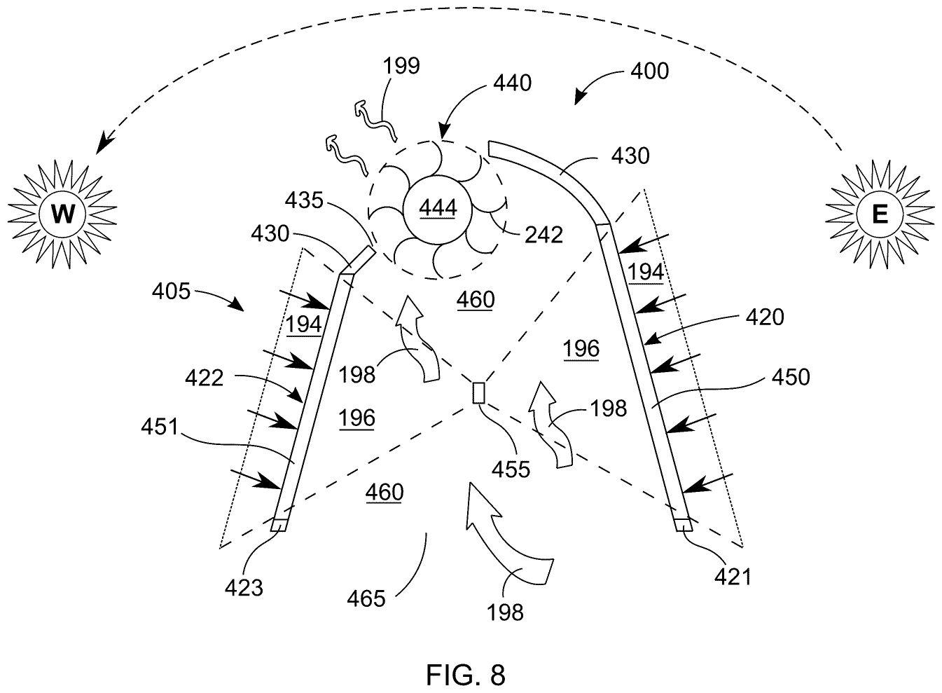

Referring now to FIG. 8, which provides a cross sectional view of the energy harvesting device 400 of FIG. 7, the trough 405 defines a channel 460 having an opening 465.

The energy harvesting 400 device is positioned on the roof of a building (not shown) such that its longitudinal length is generally North-South orientated. When the sun is in the East (E), incident sunlight 194 enters the trough 405 via the first Fresnel lens 450 in the first side 420 of the trough 405, to provide concentrated sunlight 196 inside the channel 460.

Concentrated sunlight 196 is directed and focused by the first Fresnel lens 450 onto the solar receiver 455 positioned in the middle of the trough 405. As the sun moves across the sky from East (E) to West (W) throughout the day, the amount of sunlight entering the trough 405 via the first Fresnel lens 450 in the first side 420 gradually decreases. However, once the sun is in the West (W), incident sunlight 194 enters the trough 405 via the second Fresnel lens 451 in the second side 422 of the trough 405, to provide concentrated sunlight 196 inside the channel 460. Concentrated sunlight 196 is directed and focused by the second Fresnel lens 451 onto the solar receiver 455 positioned in the middle of the trough 405.

The solar receiver 455 can convert the concentrated sunlight 196 received from the first and second Fresnel lenses 450, 451 into electrical or heat energy for use in a building to which it is attached (not shown).

The concentrated sunlight 196 also increases the temperature of air in the channel 460. This creates an area of low pressure within the channel 460, which draws wind 198 through the channel 460 and accelerates it towards wind turbine 440. Wind 198 flows across the blades 442 of the wind turbine 440, and out through the elongate slot 435, causing the blades 442 to rotate about their axis. This results in rotation of the shaft 444 to generate mechanical energy, which can be converted into electrical or heat energy. Wind 198 exits the elongate slot 435 of base portion 430 as a stream of exhaust air 199.

I claim:

1. An energy harvesting device comprising:
a solar concentrator;
a solar receiver;
a frame configured to retain the solar concentrator and the solar receiver in parallel; wherein
the frame facilitates a variation of a perpendicular distance between the solar concentrator and solar receiver;
the device includes a sun-tracking mechanism configured to orient an incident-facing surface of the solar concentrator substantially perpendicular to incident sunlight; and
the device is further configured to adjust the perpendicular distance between the solar concentrator and the solar receiver during operation such that redirected sunlight remains focused onto the solar receiver.

2. The energy harvesting device of claim 1, wherein
the solar concentrator includes a Fresnel lens.

3. The energy harvesting device of claim 1, wherein
the solar concentrator includes a parabolic reflector.

4. The energy harvesting device of claim 1, wherein
the frame is rotatable about an axis parallel with a horizon.

5. The energy harvesting device of claim 1, wherein
the frame is rotatable about an axis perpendicular to a horizon.

6. The energy harvesting device of claim 1, wherein
the solar concentrator is configured to focus incident sunlight into a linear focal region.

7. The energy harvesting device of claim 1, wherein
the adjustable range of motion between the solar concentrator and the solar receiver spans at least 50% of the distance between opposing first and second structural walls of the energy harvesting device.

8. The energy harvesting device of claim 1, wherein
at least one of a cross-sectional profile of the solar concentrator and a cross-sectional profile of the solar receiver remains substantially uniform along its maximum linear dimension.

9. The energy harvesting device of claim 1, wherein
the solar receiver is a solar-thermal panel.

10. The energy harvesting device of claim 1, wherein
the solar receiver comprises a solar hot-water panel or a through-pass air collector.

11. The energy harvesting device of claim 1, wherein
the solar concentrator is fixed; and
the device is configured to continuously or periodically adjust the perpendicular distance between the solar concentrator and solar receiver such that sunlight redirected by the solar concentrator is focused onto the solar receiver.

12. The energy harvesting device of claim 1, wherein
a maximum linear dimension of the solar concentrator is oriented horizontally; and
a maximum linear dimension of the solar receiver is oriented horizontally.

13. The energy harvesting device of claim 1, wherein
a maximum linear dimension of the solar concentrator is oriented at an angle greater than 45 degrees from the horizon; and
a maximum linear dimension of the solar receiver is oriented at an angle greater than 45 degrees from the horizon.

14. An energy harvesting device comprising:
a solar concentrator;
a solar receiver;
a frame configured to retain the solar concentrator and the solar receiver in parallel; wherein
the solar concentrator is fixed;
the frame facilitates a variation of a perpendicular distance between the solar concentrator and solar receiver;
the frame does not facilitate a motion of the solar concentrator orthogonal to the perpendicular distance; and
the device is further configured to adjust the perpendicular distance between the solar concentrator and the solar receiver during operation such that redirected sunlight remains focused onto the solar receiver.

15. The energy harvesting device of claim 14, wherein
the frame is rotatable about an axis parallel with a horizon; and
the device includes a sun-tracking mechanism configured to orient an incident-facing surface of the solar concentrator substantially perpendicular to incident sunlight.

16. The energy harvesting device of claim 14, wherein
a maximum linear dimension of the solar concentrator is oriented horizontally; and
a maximum linear dimension of the solar receiver is oriented horizontally.

17. The energy harvesting device of claim 14, wherein
a maximum linear dimension of the solar concentrator is oriented at an angle greater than 45 degrees from the horizon; and
a maximum linear dimension of the solar receiver is oriented at an angle greater than 45 degrees from the horizon.

18. The energy harvesting device of claim 14, wherein
at least one of a cross-sectional profile of the solar concentrator and a cross-sectional profile of the solar receiver remains substantially uniform along its maximum linear dimension.

19. The energy harvesting device of claim 14, wherein
the solar receiver is a solar-thermal panel.

20. The energy harvesting device of claim 14, wherein
the solar receiver comprises a solar hot-water panel or a through-pass air collector.
